(19) United States
(12) Patent Application Publication
(10) Pub. No.: US 2019/0096421 A1
(43) Pub. Date: Mar. 28, 2019

(54) FREQUENCY DOMAIN NOISE ATTENUATION UTILIZING TWO TRANSDUCERS

(71) Applicant: Creative Technology Ltd, Singapore (SG)

(72) Inventor: Jean Laroche, Santa Cruz, CA (US)

(21) Appl. No.: 16/142,670

(22) Filed: Sep. 26, 2018

Related U.S. Application Data
(63) Continuation of application No. 15/233,806, filed on Aug. 10, 2016, now abandoned.
Application No. 15/233,806 is a continuation of application No. 11/399,062, filed on Apr. 5, 2006, now abandoned.

(51) Int. Cl. G10L 21/0232; H04M 1/60; H04R 3/00; G10L 21/0332; G10L 25/84; G10L 21/0216; H04M 9/08

(52) U.S. Cl. CPC G10L 21/0232; H04M 1/6033; H04R 3/005; H04M 9/085; G10L 25/84; G10L 2021/02165; G10L 21/0332

(57) ABSTRACT

Embodiments may find applications to ambient noise attenuation in cell phones, for example, where a second microphone is placed at a distance from the voice microphone so that ambient noise is present at both the voice microphone and the second microphone, but where the user's voice is primarily picked up at the voice microphone. Frequency domain filtering is employed on the voice signal, so that those frequency components representing mainly ambient noise are de-emphasized relative to the other frequency components. Other embodiments are described and claimed.

### PRIORITY

This Application is a Continuation of U.S. patent application Ser. No. 15/233,806, filed on Aug. 10, 2016, which is a Continuation of U.S. patent application Ser. No. 11/399,062, filed Apr. 5, 2006, which applications are incorporated by reference herein in their entireties.

### FIELD

Embodiments of the present invention relate to signal processing, and more particularly, to digital signal processing to attenuate noise.

### BACKGROUND

Cell phone conversations are sometimes degraded due to ambient noise. For example, ambient noise at the talker's location may affect the voice quality of the talker as perceived by the listener. It would be desirable to reduce ambient noise in such communication applications.

### BRIEF DESCRIPTION OF THE DRAWINGS

FIG. 1 illustrates two simplified views of a cell phone employing an embodiment of the present invention,

FIG. 2 illustrates an embodiment of the present invention.

### DESCRIPTION OF EMBODIMENTS

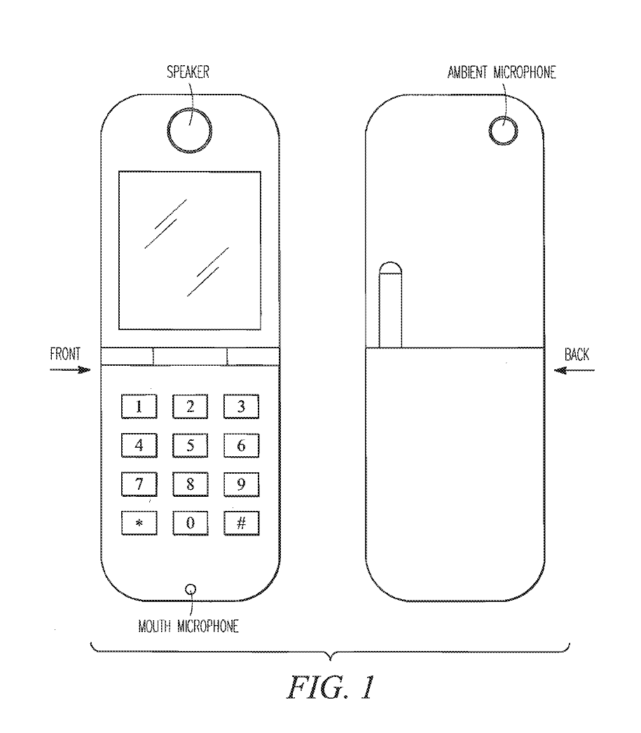

FIG. 1 provides two simplified views of a cell phone employing an embodiment of the present invention. Unlike conventional cell phones, the cell phone of FIG. 1 has a microphone placed at a distance from the main microphone used for the voice. This microphone is indicated as “ambient microphone” in FIG. 1, whereas the microphone intended for the user's voice is indicated as “mouth microphone”. In the embodiment of FIG. 1, the ambient microphone on the back side of the cell phone. However, in other embodiments, the ambient microphone may be situated at other locations on the cell phone.

Generally stated, embodiments of the present invention make use of the two signals provided by the mouth and ambient microphones to process the signal from the mouth microphone so as to attenuate ambient noise. It is expected that ambient noise will be present at substantially the same power levels at the locations of the ambient and mouth microphones, but that the voice of the user will have a much higher power level at the location of the mouth microphone than for the ambient microphone. Embodiments of the present invention exploit this assumption to provide frequency domain filtering, where those frequency components identified has having mainly a voice contribution are emphasized relative to the other frequency components.

Embodiments of the present invention are not limited to cell phones, but may find applications in other systems.

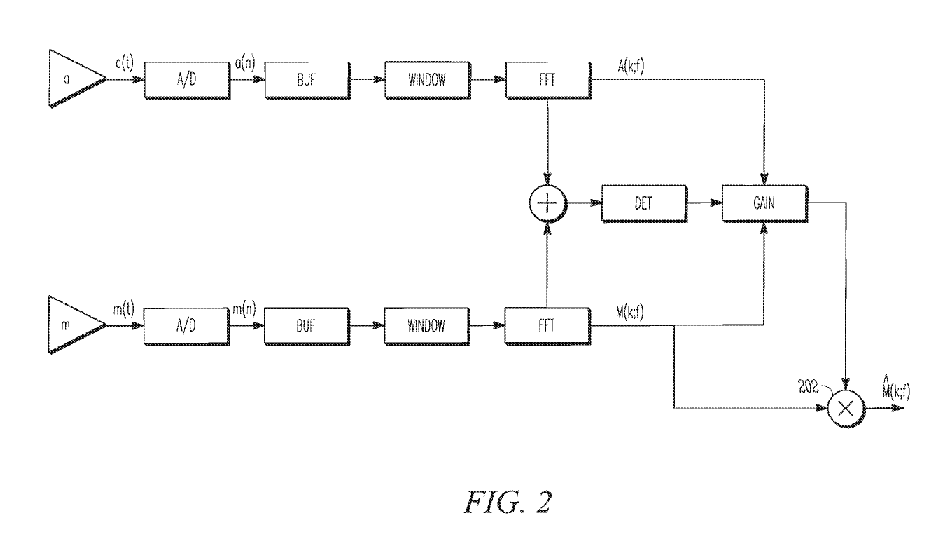

FIG. 2 provides a high-level abstraction of some embodiments of the present invention. FIG. 2 comprises various modules (functional blocks), where a module may represent a circuit, a software or firmware module, or some combination thereof. Accordingly, FIG. 2 aids in a description of exemplary apparatus embodiments as well as exemplary method embodiments.

Referring to FIG. 2, signal a(t) is provided by transducer a, and signal m(t) is provided by transducer m. These signals are time domain signals, where the index t represents time. The signals may be voltage signals, or current signals. Transducer a and transducer b may be microphones, for example, but are not limited to merely microphones. For example, in application to a cell phone, transducer m may be the mouth microphone in FIG. 1 and transducer a may be the ambient microphone in FIG. 1, where for convenience identifying in with “mouth” and a with “ambient” may serve as a mnemonic.

A/D modules in FIG. 2 denote analog-to-digital converters, one AD converter for signal a(t) and one A/D converter for signal m(t). The output of the A/D converter for signal a(t) may be represented by the discrete time series a(n), and the output of the AD converter for signal m(t) may be represented by the discrete time series m(n), where n is a discrete time index. In practice, the symbol a(n), or m(n), for any discrete time index n represents a binary word in some kind of computer arithmetic representation, such as integer arithmetic or floating-point arithmetic. The particular implementation details are not important to an understanding of the embodiments, and for ease of discussion the symbol a(n), or m(n), may be viewed as representing a real number. Similar remarks apply to various other numerical symbols used to describe the embodiments. For example, some symbols will be introduced to represent complex numbers.

The BUF modules for the discrete time series a(n) and m(n) represent buffers to store a fixed number of samples of a(n) and m(n). The fixed number of samples may be taken to be the size of the analysis window applied to these discrete time series. WINDOW modules apply an analysis window to their respective discrete time series, where the analysis window is a set of weights, where each discrete time sample in a BUF module is multiplied by one of the weights.

For example, at some particular time, the samples of m(n) stored in its BUF module may be represented by m(n), n=n₀, n₀+1, . . . , n₀+N−1, where N is the number of samples. Denoting the set of window weights by W(i), i=0,1, . . . , . . . N−1, the output of WINDOW module is the set of N numbers:

{m(n₀)W(0), m(n_{b+1})W(1), . . . , m(n₀N−1)W(N−1)}.

The above set of numbers after analysis windowing may be referred to as a frame. Frames may be computed at the rate of one frame for each N samples of m(n), or overlapping may be used, where frames are computed at the rate of one frame for each N/r samples of m(n), where r is an integer that divides into N. The resulting sequence of frames may be represented by m̅(f), where f is a discrete frame index. Similar remarks apply to the discrete time series a(n), where the resulting sequence of frames may be represented by ā(f).

FFT modules in FIG. 2 refer to modules for performing a fast Fourier transform on a frame. More generally, a discrete Fourier transform (DFT) is applied, where a FFT merely denotes a particular algorithm for implementing a DFT. In other embodiments, other transforms may be applied. Such transforms map a time domain signal into a frequency domain signal. For each frame index f, the DFT of frame m̅(f) is denoted as M(k; f), where k is a frequency bin index belonging to a frequency bin index set {0, 1, . . . , K−1}. The DFT of frame ā(f) is denoted as A(k; f) Often K=N, but various interpolation techniques may be employed so that K≠N for some embodiments.

DET module partitions, for each frame index f, the index set {0,1, . . . , K−1} into disjoint partitions P(j; f), j=0,1, . . . , J(f)−1, where j is a partition index and J(f) denotes the number of partitions for frame index f, where

$${⋃}_{j = 0}^{J ( f ) - 1} P ( j ; f ) = \{ 0 , 1 , … , K - 1 \} .$$

For each partition there is one index k*(j; f) ∈ P(j; f) such that

|M(k*(j; f); f)+A(k*(j;f); f)|

is a maximum over the partition P(j; f).

Embodiments may construct these partitions in various ways. For some embodiments, the partitions may be constructed as follows. For a given frame index f, all frequency bin indices k* are found for which

|M(k*−1; f)+A(k*−1; f)|≤|M(k*; f)+A(k*; f)|,

|M(k*+1; f)+A(k*+1; f)|≤|M(k*; f)+A(k*; f)|. (1)

Once the set of all such frequency bin indices is determined, each one indicating a local maximum of the function |M(k; f)+A(k; f)| in frequency bin space, the frequency bin index set is partitioned so that each partition boundary is half-way, or closest to half-way, between two adjacent such indices.

Other embodiments may construct partitions in other ways. For example, partitions may be constructed based upon local maximums of the function A(k; f). More generally, partitions may be constructed based upon local maximums of a functional of the functions A(k; f) and M(k; f). For example, in Eq. (1), the functional is the addition operator applied to the functions A(k; f) and M(k; f).

It should be noted that the statements in the previous paragraph regarding the frequency bin indices are interpreted in modulo K arithmetic. For example, k*−1 in the earlier displayed equation is to be read as (k*−1)mod(K). Similarly, the “half-way” frequency bin index between any two frequency bin indices for local maximums is interpreted with respect to modulo K arithmetic. Accordingly, the various partitions are contiguous if one imagines the frequency bin index set forming a circle, where 0 is adjacent to both 1 and K−1.

Other embodiments may choose the partitions in other ways, and may define the local maximum in different ways. For example, the relationship ≤ in Eq. (1) may be replaced with <, whereas the relationship < may be replaced with ≤.

It is convenient to denote the indices for the local maximums by k*(j; f), j=0,1, . . . , J(f)−1. That is, for j=0,1, . . . , J(f)−1, k*(j; f) ∈ P(j; f) and |M(k*; f)+A(k*; f)| is a maximum over the partition P(j; f).

GAIN module makes use of the information provided by DET module to compute gains for each partition. In some embodiments, the gain for partition P(j; f), denoted by G(j; f), is provided by a function F(R) of the ratio

$$R = \vert \frac{A ( {k}^{*} ( j ; f ) ; f )}{M ( {k}^{*} ( j ; f ) ; f )} \vert .$$

For some embodiments, the function F(R) may be

$$F ( R ) = \{ \begin{matrix}1 & R \leq T , \\ {10}^{- α log ( R \text{/} T )} & R > T ,\end{matrix}$$

where T is a threshold. For some other embodiments, the function F(R) may be

$$F ( R ) = \{ \begin{matrix}1 & R \leq T \\ 0 & R > T .\end{matrix}$$

The above equations may be generalized so that the numeral 1 is replaced by some scalar, denoted as G₀, where G₀ is independent of j. That is, the function F(R) may be

$$F ( R ) = \{ \begin{matrix}{G}_{0} & R \leq T , \\ {G}_{0} {10}^{- α log ( R \text{/} T )} & R > T ,\end{matrix}$$

or may be

$$F ( R ) = \{ \begin{matrix}{G}_{0} & R \leq T , \\ 0 & R > T .\end{matrix}$$

For some embodiments, the threshold T may be on the order of 1/10 to 1/100. In some other embodiments, it may also be higher, such as for example ½ or ¼. In practice, when an embodiment is used in a cell phone, it is expected that the mouth microphone is much closer to the speaker's mouth than the ambient microphone. Consequently, when the cell phone is in use and the user is speaking into the mouth microphone, it is expected that for a frequency bin kₘ for which there is energy contribution from the user's voice, the magnitude of M(kₘ; f) is much larger than the magnitude of A(kₘ; f), whereas for a frequency bin kₐ for which there is relatively little energy contribution from the user's voice, the magnitude of M(kₐ; f) is not much larger than, or perhaps comparable to, the magnitude of A(kₐ; f). Consequently, for cell phone applications, by setting the threshold to a relatively small number, the frequency bins containing mainly voice energy are easily distinguished from the frequency bins for which the user's voice signal has a relatively small energy content.

Multiplier 202 multiplies M(k; f) by a gain for each frame index f and each frequency bin index k. The result of this product is denoted as \tilde{M}(k; f) in FIG. 2. Using a synthesis window on \tilde{M}(k; f), a time domain signal \hat{m}(t) may be reconstructed. In applications in the cell phone of FIG. 1, it is expected that the voice signal in m(t) has a much larger power spectral density than that in a(t), and that ambient noise will be present in both m(t) and a(t) with comparable power spectral density. It is expected that for the proper choice of gain for each M(k; f), the reconstructed time domain signal \hat{m}(t) is a more pleasing reproduction of the actual voice of the user.

The gain used for multiplication may be G(j; f), where for each partition index j, each M(k; f) such that k belongs to P(j; f) is multiplied by G(j; f). However, it is expected that with this choice of gain, the resulting signal \hat{m}(t) may be of poor quality, with large amounts of so-called “musical noise”. This is expected because sonic frequency components may result in a ratio R that varies substantially from frame to frame, sometimes being above the threshold T, and at other times being below T. This results in some frequency components “popping” in and out when \hat{m}(t) is formed, resulting in “chirps” that quickly fade in and out.

This problem may be minimized in some embodiments by smoothing the computed gains G(j; f). For example, an “attack-release” smoothing method may be applied as follows. For each frame index f, and for each frequency bin index k, M(k; f) is multiplied by a smoothed gain Ĝ(k; f) to form the product \hat{M}(k; f)=M(k; f)Ĝ(k; f), where Ĝ(k; f) is given by

$${G}^{⋒} ( k ; f ) = \{ \begin{matrix}{β}_{a} G ( l ; f ) + ( 1 - {β}_{a} ) {G}^{⋒} ( k ; f - 1 ) , for G ( l ; f ) > {G}^{⋒} ( k ; f ) , \\ {β}_{r} G ( l ; f ) + ( 1 - {β}_{r} ) {G}^{⋒} ( k ; f - 1 ) , for G ( l ; f ) \leq {G}^{⋒} ( k ; f ) ,\end{matrix}$$

where G(l; f) is the gain for the partition P(l; f) to which k belongs, i.e., k ∈ P(l; f), and where βₐ and βᵣ are positive numbers less than one.

The number βₐ is an “attack” smoothing control weight, applied when the computed gain G(j; f) increases from one frame to the next, and the number βᵣ is a “release” control weight, applied when the gain G(j; f) decreases from one frame to the next. Typically, βₐ is chosen relatively small, so that the smoothed gain Ĝ(k; f) slowly increases if G(j; f) increases from one frame to the next; and βᵣ is chosen close to one, so that the smoothed gain Ĝ(k; f) rapidly decreases if the gain G(j; f) decreases from one frame to the next. With this choice for these weights, it is expected that musical-noise components are attenuated because their corresponding gains G(j; f) do not have enough time to rise before they dip back down, whereas voice components most likely will not be seriously affected because their corresponding gains G(j; f) usually remain relatively large for many consecutive frames. For some embodiments, βₐ may be adjusted during an initialization period, so that when the user starts speaking into the in microphone, the beginning of the utterance is not seriously affected by the slow rise time of the smoothed gain.

Other embodiments may smooth the gains G(j; f) using other types of smoothing algorithms.

Various modifications may be made to the disclosed embodiments without departing from the scope of the invention as claimed below. For example, is to be understood that some of the modules or functional blocks described in the embodiments may be grouped together into various larger modules, or some of the modules may comprise various sub-modules. Furthermore, various modules may be realized by application specific integrated circuits, processors running software, programmable field arrays, logic with firmware, or some combination thereof.

For some embodiments, the threshold value T is constant, but for other embodiments, the threshold value T may vary. For example, the threshold value may be a function of the frame index, the frequency bin index, or both.

It is to be understood that the scope of the invention is not limited by the placement of the first and second transducers relative to a speech source. Furthermore, it is to be understood that the scope of the invention is not limited to any particular distance, orientation, or directionality characteristic (or combination thereof) of the first and second transducers, where these characteristics may be selected to help differentiate between a first signal and a second signal, such as for example to differentiate ambient noise from a desired voice signal.

Throughout the description of the embodiments, various mathematical relationships are used to describe relationships among one or more quantities. For example, a mathematical relationship may express a relationship by which a quantity is derived from one or more other quantities by way of various mathematical operations, such as addition, subtraction, multiplication, division, etc. For example, the DFT or FFT may be performed on a frame of a time sampled signal. These numerical relationships and transformations are in practice not satisfied exactly, and should therefore be interpreted as “designed for” relationships and transformations. For example, it is understood that such transformations as a DFT or FFT cannot be done with infinite precision. One of ordinary skill in the art may design various working embodiments to satisfy various mathematical relationships or numerical transformations, but these relationships or numerical transformations can only be met within the tolerances of the technology available to the practitioner.

Accordingly, in the following claims, it is to be understood that claimed mathematical relationships or transformations can in practice only be met within the tolerances or precision of the technology available to the practitioner, and that the scope of the claimed subject matter includes those embodiments that substantially satisfy the mathematical relationships or transformations so claimed.

1. (canceled)

2. A system for reducing noise in an audio signal, the system comprising:
a signal transform circuit configured to receive time domain audio signals m(t) and a(t) from respective first and second transducers and, in response, provide respective first and second frequency domain signals M(k; f) and A(k; f), wherein k is a frequency bin index and f is a frame index; and
a processor circuit configured to:
receive the first and second frequency domain signals M(k; f) and A(k; f);
combine the first and second frequency domain signals to provide a third frequency domain signal;
identify maxima in the third frequency domain signal;
based on the identified maxima in the third frequency domain signal, partition the frequency bin indexes k to provide respective partitioned signals M(k*; f) and A(k*; f) wherein each partition index k* corresponds to one of the identified maxima; and
for each partition index k*:
determine a magnitude ratio for the partitioned signals M(k*; f) and A(k*; f) corresponding to each partition index k*;
classify the partition corresponding to each partition index k* based on a comparison of the determined magnitude ratio against a specified threshold ratio value; and
provide a respective gain g* for each partition index k* based on the classification of the partition corresponding to each partition index k*; and
generate a time-domain output signal m′(t) by applying, for each partition index k*, the respective gain g* to corresponding portions of each frame of the first frequency domain signal M(k; f), wherein the output signal m′(t) has a reduced noise characteristic relative to m(t).

3. The system of claim 2, wherein the processor circuit is configured to provide the third frequency domain signal by summing the first and second frequency domain signals.

4. The system of claim 2, wherein the processor circuit is configured to partition the frequency bin indexes k to provide the partitioned signals M(k*; f) and A(k*; f) so that each partition of the partitioned signals M(k*; f) and A(k*; f) is centered at a respective one of the identified maxima in the third frequency domain signal.

5. The system of claim 4, wherein the processor circuit is configured to partition the frequency bin indexes k to provide the partitioned signals M(k*; f) and A(k*; f) so that boundaries of the partitions are half-way between adjacent partition indexes k*.

6. The system of claim 2, further comprising the first and second transducers, including first and second microphones configured to respectively provide the time domain audio signals m(t) and a(t), wherein the first microphone is a voice microphone provided on a first side of a mobile telephone device, and wherein the second microphone is an ambient microphone provided on an opposite second side of the mobile telephone device.

7. The system of claim 2, wherein the processor circuit is configured to, for each partition index k*, classify information from the partitioned audio signals M(k*; f) and A(k*; f) as information to be amplified or attenuated based on a magnitude ratio of the partitioned audio signals at the same partition index k*.

8. The system of claim 2, wherein the processor circuit is configured to classify the partitions, for each partition index k*, as including either speech information or noise.

9. The system of claim 2, wherein the processor circuit is configured to apply smoothing to the gain g* before generating the time-domain output signal m′(t).

10. The system of claim 9, wherein the smoothing includes providing a first smoothing characteristic when the gain increases from one frame to the next, and providing a different second smoothing characteristic when the gain decreases from one frame to the next.

11. A processor-implemented method for reducing noise in an audio signal, the method comprising:
receiving first and second frequency domain signals M(k; f) and A(k; f), wherein k is a frequency bin index and f is a frame index;
combining the first and second frequency domain signals to provide a third frequency domain signal:
identifying maxima in the third frequency domain signal;
based on the identified maxima in the third frequency domain signal, partitioning the frequency bin indexes k to provide respective partitioned signals M(k*; f) and A(k*; f), wherein each partition index k* corresponds to one of the identified maxima; and
for each partition index k*:
determining a magnitude ratio for the partitioned signals M(k*; f) and A(k*; f) corresponding to each partition index k*;
classifying the partition corresponding to each partition index k* based on a comparison of the determined magnitude ratio against a specified threshold ratio value; and
providing a respective gain g* for each partition index k* based on the classification of the partition corresponding to each partition index k*; and
generating a time-domain output signal m′(t) by applying, for each partition index k*, the respective gain g* to corresponding portions of each frame of the first frequency domain signal M(k; f), wherein the output signal m′(t) has a reduced noise characteristic relative to m(t).

12. The method of claim 11, further comprising:
receiving time domain audio signals m(t) and a(t) from respective first and second transducers; and
providing the first and second frequency domain signals M(k; f) and A(k; f) based on the received time domain audio signals m(t) and a(t), respectively.

13. The method of claim 11, wherein the combining the first and second frequency domain signals includes summing the first and second frequency domain signals to provide the third frequency domain signal.

14. The method of claim 11, wherein the partitioning the frequency bin indexes k to provide the partitioned signals M(k*; f) and A(k*; f) includes partitioning such that each partition of the partitioned signals M(k*;t) and A(k*; f) is centered at a respective one of the identified maxima in the third frequency domain signal.

15. The method of claim 14, wherein the partitioning the frequency bin indexes k to provide the partitioned signals M(k*;t) and A(k*; f) includes partitioning such that boundaries of the partitions are half-way between adjacent partition indexes k*.

16. The method of claim 11, further comprising classifying the partitions, for each partition index k*, as including either speech information or noise.

17. The method of claim 11, further comprising applying smoothing to the gain g* before generating the time-domain output signal m′(t).

18. The method of claim 17, wherein applying smoothing includes applying a first smoothing characteristic when the gain increases from one frame to the next, and applying a different second smoothing characteristic when the gain decreases from one frame to the next.

19. A system for reducing noise in an audio signal, the system comprising:
a signal processing circuit configured to:
receive frequency domain first and second partitioned audio signals M(k*; f) and A(k*; f) based on respective first and second reference signals, wherein each of the partitioned audio signals is partitioned into frequency bins k* according to signal magnitude peaks as identified using information from a combination of the first and second reference signals;
for each frequency bin k*, classify information from the first and second partitioned audio signals M(k*; f) and A(k*; f) as information to be amplified or attenuated based on a magnitude ratio of the first and second partitioned audio signals M(k*;t) and A(k*; f) at frequency bin k*; and
provide a gain g* to be applied to the first reference signal based on a comparison of the magnitude ratio with a specified reference ratio value.

20. The system of claim 19, wherein the signal processing circuit is configured to sum the first and second reference signals to provide the combination of the first and second reference signals.

21. The system of claim 19, further comprising first and second microphones, wherein the first microphone is configured to provide the first reference signal based on primarily speech information, and wherein the second microphone is configured to provide the second reference signal based on primarily ambient noise information.
